(19) United States
(12) Patent Application Publication
(10) Pub. No.: US 2017/0273330 A1
(43) Pub. Date: Sep. 28, 2017

(54) LIQUID CREAMERS CONTAINING A COMBINATION OF NATURAL OIL SOLUBLE AND WATER DISPERSIBLE ANTIOXIDANTS

(71) Applicant: NESTEC S.A., Vevey (CH)

(72) Inventors: Guillermo Napolitano, Dublin, OH (US); Alexander A. Sher, Dublin, OH (US)

(21) Appl. No.: 15/503,870

(22) PCT Filed: Aug. 5, 2015
(86) PCT No.: PCT/EP2015/068112

§ 371 Date: Feb. 14, 2017

Related U.S. Application Data
(60) Provisional application No. 62/037,454, filed on Aug. 14, 2014.

(51) Int. Cl. A23D 7/01; A23L 2/52; A23L 9/20; A23L 33/15; A23L 29/10; A23C 11/06

(52) U.S. Cl. CPC A23D 7/011; A23L 29/10; A23C 11/06; A23L 9/24; A23L 33/15; A23L 2/52; A23C 2240/15

(57) ABSTRACT

The present invention relates to a liquid creamer composition comprising unsaturated high oleic oils in an amount from 65 to 95% by weight of the total fat in the creamer composition, oil soluble antioxidants and water soluble or dispersible natural plant extract antioxidants. The invention also relates to a beverage composition comprising the liquid creamer composition, and a method of making it.

### FIELD OF THE INVENTION

The present invention relates to creamers that may be used as such or for adding to coffee, tea, and cocoa beverages, cereals, and to methods of producing creamers.

### BACKGROUND

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel.

Emulsions and suspensions are not thermodynamically stable, and there is a real challenge to overcome physico-chemical instability issues in the liquid creamers that contain oil and other insoluble materials, especially for the aseptic liquid creamers during long storage times at ambient or elevated temperatures. Moreover, over time, creaming that can still be invisible in the liquid beverages stored at room and elevated temperatures can cause a plug in the bottle when refrigerated. Furthermore, chemical instability issues such as oxidation result in lower quality product and shorter shelf life.

Traditionally, fats and oils used in non-dairy liquid creamers have a high concentration of saturated and/or trans fatty acids. Both types of fatty acids, however, are known to increase the risk factors for cardiovascular and other chronic diseases. To avoid an increase in risk factors, non-dairy liquid creamers have been made with healthier unsaturated oils. However, the creamers made with unsaturated oils have short shelf lives due to rapid oxidation and development of unpleasant off-flavors.

Coffee creamers containing healthier oils rich in unsaturated fatty acids are prone to oxidation and to the development of off-flavors. This problem is particularly prevalent in products expected to be shelf stable and stored at ambient temperatures.

WO/2011064167 discloses an oxidative stability based on oil blend. The blend comprises at least one oil selected from the group consisting of coconut oil, palm oil, palm oil fractions, high oleic sunflower oil, and combinations thereof. The blend should comprise no more than 80% by weight saturated fatty acids, and no more than 1% by weight trans fatty acids. A particular oil blend comprising from about 50% to about 80% coconut oil and from about 20% to about 50% high oleic sunflower oil by total weight of the oil blend are disclosed. There is a need for a further improved product that is trans acid “free” and has a lower level of total fatty acid content.

Oils that remain liquid and do not plug at both ambient and refrigerated temperatures are highly unsaturated and in consequence oxidative unstable. Development of rancid or other off flavours due to oxidation of the fat component is a serious concern for the shelf-life of liquid creamers. Existing solutions include the use of fully or partially hydrogenated oils with a high content of saturated or trans-fatty acids, respectively, and/or the use of artificial antioxidants. The use of hydrogenated oils, however, may be undesirable as a product with hydrogenated oil may be perceived as being less healthy, less natural, and of a lower quality. Un-hydrogenated domestic commodity oils (such as soybean, canola and sunflower oils) have a tendency for rapid development of rancidity during storage.

In view of the previous discussion, there are challenges in and a need for creating non-dairy liquid creamers that are oxidative and emulsion stable for a required shelf life, but also contain no or very low concentrations of trans fatty acids and moderate levels of unsaturated fatty acids.

### SUMMARY OF THE INVENTION

It was surprisingly found that combinations of natural antioxidants and in particular in the specified concentration ranges provided stability to oxidative sensitive oils in the complex creamers matrix.

Accordingly, the present invention relates to a liquid creamer composition comprising unsaturated high oleic oils in an amount from 65 to 95% by weight of the total fat in the creamer composition, oil soluble antioxidants and water soluble or dispersible natural plant extract antioxidants.

The present invention combine the use of natural oil antioxidants and water soluble/dispersible natural plant extract antioxidants to prevent the oxidation of sensitive oils in emulsions. The oxidation of oils in bulk and especially in oil in water emulsions is a very complex. The present invention provides a solution to this problem.

It has been found that an improved protection against oxidation can be obtained by the oil comprising oil soluble antioxidants and water soluble or water dispersible lipid antioxidants. The oil soluble antioxidants are preferably added before the oil is shipped to the factory for production. The oil soluble antioxidants will protect the oil during transportation and storage before production and also provides protection of the oil phase of the emulsion during the shelf life of the product. The water soluble or water dispersible lipid antioxidants and metal chelator of natural origin (e.g., hydrolyzed vegetable proteins, tea polyphenols) that are added to the water phase during production. These plant extracts have metal chelating properties similar to EDTA (Ethylenediaminetetraacetic acid), which inactivate pro-oxidant metals present in the emulsion or in the machinery.

These water dispersible antioxidants contain an emulsifier (e.g. polyglycerol ester), favoring the migration of the antioxidant system to the oil water interface of the emulsion.

According to the present invention all antioxidants are preferably of natural origin derived from plant extracts, such as rosemary, sage and oregano. The extracts themselves may not be water dispersible but they are formulated with certain emulsifiers that make them water dispersible.

It is known that oil oxidation in creamers is prevented by using oil soluble or water dispersible ingredients, but not by a combination of both. Most commonly used water dispersible metal chelators are synthetic, such as EDTA or citric acid. It was unexpectedly found that only the natural spice extractives (containing phenolic compounds) in combination with oil soluble antioxidants provided similar antioxidant activity as best in the class synthetic chelator but being natural. Moreover, the prevention of oxidation works particular well with one type of oil soluble antioxidant, namely tocopherols. Furthermore, this works particular well at specific ratios with tocopherols. Anybody skilled in the art will assume that the higher level of antioxidants are used, the better will be an antioxidant effect, but it was surprisingly found that higher level of the water soluble antioxidant did not provide the better effect.

In a preferred embodiment of the invention the oil soluble antioxidant has tocopherols in a concentration of at least 100 ppm. It is also preferred that the water soluble or dispersible natural plant extract in a concentration of at least 50 ppm. It has been found that if the combination of the antioxidants has less than 100 ppm of tocopherols and less than 50 ppm of the plant extracts, it did not provide adequate protection against oxidation during the products shelf life storage.

Preferable, the creamer composition according to the invention comprises oil soluble tocopherols in a concentration between 100 ppm and 1000 ppm. It is also preferred that the creamer composition comprises water soluble or dispersible natural plant extract in a concentration between 50 and 1000 ppm. It has been found that the use of the combination of the antioxidants above in the range of concentrations of 1000 ppm of tocopherols and 1000 ppm of this plant extracts provided negative results due to undesirable flavor perception and possible pro-oxidant effects.

An advantage of the present disclosure to provide improved a creamer composition being trans fatty acid free and shelf stable creamers without negative flavor perception during shelf life. Another advantage of the present disclosure is to provide improved creamer composition having low levels of saturated fatty acids.

Still another advantage of the present disclosure is to provide a shelf-stable liquid creamer. Yet another advantage of the present disclosure is to provide a liquid creamer that is oxidative and emulsion stable. Another advantage of the present disclosure is to provide a liquid creamer that has a good appearance, aroma, flavor and texture after being stored at room or refrigeration temperature for an extended period of time. Additional features and advantages are described herein, and will be apparent from, the following Detailed Description.

In a second aspect, the invention relates to a method of producing a liquid creamer composition, the method comprising mixing a high oleic oil, a protein, low molecular weight emulsifiers, buffering agent, subjecting the mixture to UHT heat treatment and homogenizing and aseptically filling it into a package.

In a further aspect, the invention relates to a method of preparing a beverage composition, the method comprising:

a) providing a beverage composition base; and
b) adding a liquid creamer composition as described above to the beverage composition base.

### DETAILED DESCRIPTION OF THE INVENTION

According to the present invention a creamer composition is provided which has a good chemical stability. By chemical stability is meant resistance to oxidation in an amount that it deteriorates the product. In addition to the above the present invention provides a liquid creamer composition with good physical stability.

By a creamer composition is meant a composition that is intended to be added to a food composition, such as e.g. coffee or tea, to impart specific characteristics such as colour (e.g. whitening effect), thickening, flavour, texture, and/or other desired characteristics. A creamer composition of the invention is preferably in liquid form, but may also be in powdered form.

By oil soluble antioxidants is meant that antioxidant is freely dissolved in oil but does not dissolve in water.

By water soluble or dispersible natural plant extract antioxidants is meant that they form a continuous homogeneous system when added to water.

By high oleic oil is meant oils that is high in oleic acid (>60% of total fatty acids) and low in Linoleic acid (<20% of total fatty acids).

Tocopherols are mixes of natural tocopherols extracted from oil seeds and rich in the gamma-tocopherol homolog.

For the best mouthfeel, and physico-chemical properties as such and when added to hot coffee, the creamer composition comprises any of the preceding claims comprising between about 2% and about 30% oil.

Preferably, the unsaturated oil comprises a vegetable oil selected from the group consisting of high oleic canola, high oleic soybean oil, high oleic sunflower, high oleic safflower or a combination thereof.

In the present context a full fat creamer comprises above 6% fat while a low fat creamer comprises below 4% fat.

Further in the present context unless otherwise indicated % of a component means the % of weight based on the weight of the creamer composition, i.e. weight/weight %.

The water soluble/dispersible natural plant extract preferably comprises spice extract containing polyphenols.

In a preferred embodiment of the invention the oil soluble antioxidant is selected from the group consisting of tocopherols extracted from soybean, sunflower oils or combination of thereof.

A creamer composition according to the invention may comprise oil that comprises less than 2% trans fatty acid by weight of the total fat in the creamer composition. It is however preferred that the creamer is substantially free from trans fatty acid. For practical purposes “free” means less than 0.5 g of trans fatty acids/serving size, such as is required according to US FDA regulations in order to be “free” of trans fatty acids. The creamer may also be completely free from trans fatty acids.

According to the invention it is possible to provide creamers which are trans fatty acid “free” and which have a level of saturation is less than 20% of total fatty acid content.

The liquid creamer composition of the invention preferably comprising between about 0.1% and about 1.5% protein by weight of the creamer composition. The use of proteins in amount of less than 0.1% did not provide stable emulsion in liquid creamers, while addition of proteins in amount above 1.5% resulted in sedimentation during storage.

The creamer composition of the invention further comprises protein, preferably between about 0.1% (weight/weight) and about 1.5% protein, such as between about 0.2% (weight/weight) and about 1.3% protein, more preferably between about 0.5% (weight/weight) and about 1% protein. The protein may be any suitable protein, e.g. milk protein, such as casein, caseinate, and whey protein; vegetable protein, e.g. soy and/or pea protein; and/or combinations thereof. The protein is preferably sodium caseinate. The protein in the composition may work as an emulsifier, but may also provide texture, and/or provide whitening effect. Too low levels of protein reduce the stability of the liquid creamer and creaming may occur. At high protein levels phase separation occurs in creamer as is and especially when the creamer is added to hot coffee. Moreover, high level of proteins cause feathering when added to coffee prepared with hard water.

Advantageously, the creamer composition according to the invention comprises emulsifiers that are low molecular weight emulsifiers and ranging from about 0.2 to about 0.7% by weight.

In one embodiment of the invention, the creamer composition is devoid of added low molecular weight emulsifiers. By a low molecular weight emulsifier is meant an emulsifier with a molecular weight below about 1500 g/mol. Emulsions are thermodynamically unstable, and the phases of an emulsion will separate with time. By an emulsifier is meant a compound that stabilises the interface between the two phases of the oil-in-water emulsion and reduces the rate of phase separation. By the term “devoid of added low molecular emulsifiers” is meant that the creamer composition does not contain any low molecular emulsifiers which have been added in amounts sufficient to substantially affect the stability the emulsion. A creamer composition devoid of added low molecular emulsifiers may contain minor amounts of low molecular emulsifiers which do not substantially affect the stability of the emulsion, but which are present e.g. as minor impurities of one or more of the ingredients of the creamer composition.

Low molecular weight emulsifiers include, but are not limited to, monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and diglycerides, lecithins, lysolecitins, and sucrose esters of fatty acids.

In one embodiment a creamer composition according to the invention is devoid of added monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and/or diglycerides, and sucrose esters of fatty acids.

The creamer composition of the present invention may further include a buffering agent. The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 1% by weight of the liquid creamer.

The creamer composition of the present invention may further include one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5% to about 40% by weight. In another embodiment, the sweetener concentration ranges from about 25% to about 30% by weight.

The invention further relates to a method of producing a creamer composition of the invention. The method comprises providing a composition, the composition comprising water, high oleic oils, proteins, emulsifiers, buffers and optionally, sugars, flavors, colours, vitamins and minerals.

Before homogenisation, optional compounds such as, hydrocolloids, sweeteners and/or flavors may be hydrated in water (e.g., at between 40° C. and 90° C.) under agitation, with addition of melted oil if desired. The method may further comprise heat treating the composition before homogenisation, e.g. by aseptic heat treatment. Aseptic heat treatment may e.g. use direct or indirect UHT processes. UHT processes are known in the art. Examples of UHT processes include UHT sterilization and UHT pasteurization. Direct heat treatment can be performed by injecting steam into the emulsion. In this case, it may be necessary to remove excess water, for example, by flashing. Indirect heat treatment can be performed with a heat transfer interface in contact with the emulsion. The homogenization may be performed before and/or after heat treatment. It may be advantageous to perform homogenization before heat treatment if oil is present in the composition, in order to improve heat transfers in the emulsion, and thus achieve an improved heat treatment. Performing a homogenization after heat treatment usually ensures that the oil droplets in the emulsion have the desired dimension. After heat treatment the product may be filled into any suitable packaging, e.g. by aseptic filling. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference. In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono-and di-phosphates, potassium mono-and di-phosphates, sodium mono- and bi-carbonates, potassium mono- and bi-carbonates or a combination thereof. As an alternative to the Aseptic filling, Extended Shelf Life treatment can be used should the products be stored only at refrigeration (usually up to 6 months), while with aseptic filling the product can be stored at ambient temperatures.

The creamer, when added to a beverage, produces a physically stable, homogeneous, whitened drink with a good mouthfeel, and body, smooth texture, and a pleasant taste with no off-flavors notes. The use of the creamer of the invention is not limited for only coffee applications. For example, the creamer can be also used for other beverages, such as a coffee, tea, malt, cereal, or cocoa beverage composition, or used with cereals or berries, as a creamer for soups, and in many cooking applications etc.

A liquid creamer of the invention is preferably physically stable and overcome phase separation issues (e.g., creaming, plug formation, gelation, syneresis, sedimentation, etc.) during storage at refrigeration temperatures (e.g., about 4° C.), room temperatures (e.g., about 20° C.) and elevated temperatures (e.g., about 30 to 38° C.). The stable liquid creamers can have a shelf-life stability such as at least 6 months at 4° C. and/or at 20° C., 6 months at 30° C., and 1 month at 38° C. Stability may be evaluated by visual inspection of the product after storage.

The invention in an even further aspect relates to a beverage composition comprising a creamer composition as disclosed above. A beverage composition may e.g. be a coffee, tea, malt, cereal or cocoa beverage. A beverage composition may be liquid or in powder form. Accordingly, the invention relates to a beverage composition comprising a) a creamer composition of the invention, and b) a coffee, tea, malt, cereal, or cocoa product, e.g. an extract of coffee, tea, malt, or cocoa. If the beverage composition is in liquid form it may e.g. be packaged in cans, glass bottles, plastic bottles, or any other suitable packaging. The beverage composition may be aseptically packaged. The beverage composition may be produced by a method comprising a) providing a beverage composition base; and b) adding a creamer composition according to the invention to the beverage composition base. By a beverage composition base is understood a composition useful for producing a beverage by addition of a creamer of the invention. A beverage composition base may in itself be suitable for consumption as a beverage. A beverage composition base may e.g. be an extract of coffee, tea, malt, or cocoa.

A liquid creamer of the invention has good whitening capacity and is also stable (without feathering, de-oiling, other phase separation defects) when added to hot beverages (coffee, tea and like), even when coffee is made with hard water, and also provides good mouthfeel.

### EXAMPLES

By way of example and not limitation, the following examples are illustrative of various embodiments of the present disclosure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### Example 1

A dry blend of 10 g of sodium caseinate with 250 g of sucrose was added to the tank of hot water with above stabilizers under high agitation. After 10 minutes of mixing, emulsifiers (10 g of mono- and di-glycerides and 30 g of tartaric acid ester of mono- and di-glycerides) were added into the tank under continuous agitation. Further, 800 g of high oleic oil was added under agitation. Further, 0.8 (1000 ppm) g of mixed natural tocopherols and 1 (100 ppm) g of natural plant extract antioxidant were added into the tank under continuous agitation. Then, small amount of remained water was added to adjust the total product amount to 10 kg.

The liquid was pre-heated, UHT treated for 5 sec at 143° C., homogenized at 150/50 bar, cooled and the liquid creamer was aseptically filled into bottles. (Liquid creamers can be aseptically filled in any aseptic containers, e.g. jars, jugs or pouches).

The liquid creamer was stored 1 month at 38° C., 3 months at 30° C. and 6 months at 20° C.

No phase separation (creaming, de-oiling, marbling, etc.), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, mouth-feel, smooth texture and a good flavor without “off”-taste after storage 1 month at 38° C., 3 months at 30° C. and 6 months at 20° C.

### Example 2

A liquid creamer was prepared as in Example 1 but using 0.5 g of tocopherols instead of 10 g.

No phase separation (creaming, de-oiling, marbling, etc.), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, but oxidized flavor and “off”-taste after storage 1 month at 38° C.

### Example 3

A liquid creamer was prepared as in Example 1 but using 12 g of tocopherols instead of 10 g.

No phase separation (creaming, de-oiling, marbling, etc), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, but oxidized flavor and “off”-taste after storage 1 month at 38° C.

### Example 4

A liquid creamer was prepared as in Example 1 but using 0.25 g of natural plant extract antioxidant instead of 2 g.

No phase separation (creaming, de-oiling, marbling, etc.), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, but oxidized flavor and “off”-taste after storage 1 month at 38° C.

### Example 5

A liquid creamer was prepared as in Example 1 but using 12 g of natural plant extract antioxidant instead of 2 g.

No phase separation (creaming, de-oiling, marbling, etc), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, but oxidized flavor and “off”-taste after storage 1 month at 38° C.

1. A liquid creamer composition comprising:
unsaturated high oleic oils in an amount from 65 to 95% by weight of the total fat in the creamer composition;
oil soluble antioxidants; and
water soluble or dispersible natural plant extract antioxidants.

2. A creamer composition according to claim 1, wherein the oil soluble antioxidant has tocopherols in a concentration of at least 100 ppm.

3. A creamer composition according to claim 2, wherein the oil soluble tocopherols are at a concentration between 100 ppm and 1000 ppm.

4. A creamer composition according to claim 1, wherein the creamer composition comprises water soluble or dispersible natural plant extract at a concentration of at least 50 ppm.

5. A creamer composition according to claim 4, wherein the creamer composition comprises water soluble or dispersible natural plant extract at a concentration between 50 and 1000 ppm.

6. A creamer composition according to claim 1, wherein the unsaturated oil is selected from the group consisting of high oleic canola, high oleic soybean oil, high oleic sunflower, high oleic safflower and combinations thereof.

7. A creamer composition according to claim 1, wherein the water soluble/dispersible natural plant extract comprises tea extracts containing polyphenols.

8. A creamer composition according to claim 1, wherein the oil soluble antioxidant is selected from the group consisting of tocopherols extracted from soybean, sunflower oils and combinations thereof.

9. A creamer composition according to claim 1 wherein the amount of oil in the creamer composition is between 2 and 30% by weight of the creamer composition.

10. A creamer composition according to claim 1, further comprising between 0.1% and 1.5% protein by weight of the creamer composition.

11. A creamer composition according to claim 1, wherein the oil comprises less than 2% trans fatty acid by weight of the total fat in the creamer composition.

12. A creamer composition according to claim 1, comprising emulsifiers.

13. A beverage composition comprising a creamer composition comprising: unsaturated high oleic oils in an amount from 65 to 95% by weight of the total fat in the creamer composition; oil soluble antioxidants; and water soluble or dispersible natural plant extract antioxidants.

14. The beverage composition of claim 12 wherein the beverage is selected from the group consisting of a coffee, tea, malt, cereal, and cocoa beverage compositions.

15. A method of producing a liquid creamer composition, the method comprising
mixing a high oleic oil, a protein, low molecular weight emulsifiers, buffering agent,
subjecting the mixture to UHT heat treatment and homogenizing and aseptically filling it into a package.

16. A method of preparing a beverage composition, the method comprising:
a) providing a beverage composition base; and
b) adding a liquid creamer composition comprising: unsaturated high oleic oils in an amount from 65 to 95% by weight of the total fat in the creamer composition; oil soluble antioxidants; and water soluble or dispersible natural plant extract antioxidants to the beverage composition base.
